(19) United States
(12) Patent Application Publication
(10) Pub. No.: US 2026/0287472 A1
(43) Pub. Date: Sep. 24, 2026

(54) RUBBING DETERMINATION DEVICE FOR ROTARY MACHINE, AND RUBBING DETERMINATION METHOD

(71) Applicant: MITSUBISHI HEAVY INDUSTRIES, LTD., Tokyo (JP)

(72) Inventors: Satoshi Kumagai, Tokyo (JP); Yuta Imai, Tokyo (JP); Hiroki Takeda, Tokyo (JP); Masahiko Yamashita, Tokyo (JP); Yoshinori Tanaka, Tokyo (JP)

(73) Assignee: MITSUBISHI HEAVY INDUSTRIES, LTD., Tokyo (JP)

(21) Appl. No.: 19/480,103

(22) PCT Filed: Feb. 27, 2024
(86) PCT No.: PCT/JP2024/006902

§ 371 Date: Oct. 30, 2025

(30) Foreign Application Priority Data
May 19, 2023 (JP) 2023-083194

(51) Int. Cl. G01M 15/14

(52) U.S. Cl. CPC G01M 15/14

(57) ABSTRACT

A first signal intensity ratio is calculated as a ratio of the signal intensity in a frequency band higher than a reference frequency in the first frequency spectrum with respect to the ratio of the signal intensity in the entire frequency band of the frequency average spectrum. A second signal intensity ratio is calculated as a ratio of the signal intensity in a frequency band higher than the reference frequency in the second frequency spectrum with respect to the ratio of the signal intensity in the entire frequency band of the frequency average spectrum. A first index is calculated as a ratio of the first signal intensity ratio to the second signal intensity ratio. The presence or absence of rubbing is determined on the basis of the first index.

### TECHNICAL FIELD

The present disclosure relates to a rubbing determination device for a rotary machine and a rubbing determination method.

The present application claims priority based on Japanese Patent Application No. 2023-083194 filed in the Japan Patent Office on May 19, 2023, the contents of which are incorporated herein by reference.

### BACKGROUND ART

In a rotary machine including a rotary part that is rotatable with respect to a stationary part, such as a steam turbine, rubbing may occur in which a rotating body comes into contact with the stationary part due to a reduction in a gap present between the stationary part and the rotary part caused by thermal deformation of a casing during operation. The occurrence of the rubbing is a factor that causes performance degradation due to an increase in shaft vibration or a gap increase in the rotary machine. Therefore, there is a demand for a technique that detects the occurrence of the rubbing at an early stage and provides feedback to the operation of the rotary machine. In particular, in recent years, in rotary machines, there has been a trend to reduce gaps in order to respond to high-speed load fluctuations or to improve performance. Therefore, it is expected that the risk of rubbing occurring will further increase.

A technique using an acoustic emission (AE) sensor capable of detecting an AE signal is known as a method for determining the occurrence of the rubbing. The AE sensor can be easily added and has the capability to detect the rubbing over a wide range. Therefore, it is expected to meet the need to detect the occurrence of the rubbing or the position thereof in the rotary machine during operation to quickly and easily evaluate the occurrence of the rubbing.

In a rotary machine such as a turbine, when a fluid flows inside the rotary machine, there is a concern that a large amount of noise will be mixed in an AE signal detected by an AE sensor installed in the rotary machine and the accuracy of rubbing determination will be reduced. It is a challenge to determine the rubbing with high accuracy in an environment in which the amount of noise is large as described above. In order to address this challenge, PTL 1 proposes the following method. In this literature, first, a filtering process is performed on an AE signal acquired from an AE sensor to extract only the AE signal in a high frequency band using a bandpass filter, based on the finding that a ratio (SN ratio) of a contact signal indicating rubbing to a noise signal is high in the high frequency band (for example, in the vicinity of about 175 kHz). Then, the phase of a rotation synchronization component is calculated from the extracted AE signal, and it is determined that rubbing has occurred when the phase converges. More specifically, an index for quantifying the convergence of the phases is calculated, and it is automatically determined that rubbing has occurred when the index exceeds a threshold value.

### CITATION LIST

### Patent Literature

[PTL 1] Japanese Unexamined Patent Application Publication No. 2021-076533

### SUMMARY OF INVENTION

### Technical Problem

In PTL 1, it is determined that rubbing has occurred when the phase calculated based on the AE signal acquired from the AE sensor attached to the stationary part of the rotary machine converges. However, there is a case where the phase of the AE signal always converges regardless of whether rubbing is present or absent, depending on an attachment position of the AE sensor in the rotary machine. In this case, it is difficult to determine the occurrence of the rubbing in the rotary machine using the above-described method.

At least one embodiment of the present disclosure has been made in view of the above-described circumstances, and an object of the present disclosure is to provide a rubbing determination device for a rotary machine and a rubbing determination method that can accurately determine whether rubbing is present or absent based on an AE signal.

### Solution to Problem

In order to achieve the object, according to at least one embodiment of the present disclosure, there is provided a rubbing determination device for a rotary machine for determining rubbing in a rotary machine having a rotary part that is supported by a bearing to be rotatable with respect to a stationary part.

The rubbing determination device for a rotary machine includes:
an AE signal acquisition unit that acquires an AE signal from an AE sensor attached to the stationary part;
a signal analysis unit that specifies a local maximum value and a local minimum value for an envelope obtained by performing envelope processing on a temporal change in the AE signal and that calculates a first frequency average spectrum corresponding to a first time period including the local maximum value in the temporal change and a second frequency average spectrum corresponding to a second time period including the local minimum value in the temporal change;
a first signal intensity ratio calculation unit that calculates a first signal intensity ratio as a ratio of a signal intensity in a frequency band higher than a reference frequency in the first frequency average spectrum to a signal intensity in an entire frequency band of the first frequency average spectrum;
a second signal intensity ratio calculation unit that calculates a second signal intensity ratio as a ratio of a signal intensity in a frequency band higher than the reference frequency in the second frequency average spectrum to a ratio of a signal intensity in an entire frequency band of the second frequency average spectrum;
a first index calculation unit that calculates a first index as a ratio of the first signal intensity ratio to the second signal intensity ratio; and
a rubbing determination unit that determines whether the rubbing is present or absent based on the first index.

In order to achieve the object, according to at least one embodiment of the present disclosure, there is provided a rubbing determination method for a rotary machine for determining rubbing in a rotary machine having a rotary part that is supported by a bearing to be rotatable with respect to a stationary part.

The rubbing determination method for a rotary machine includes:
a step of acquiring an AE signal from an AE sensor attached to the stationary part;
a step of specifying a local maximum value and a local minimum value for an envelope obtained by performing envelope processing on a temporal change in the AE signal;
a step of calculating a first frequency average spectrum corresponding to a first time period including the local maximum value in the temporal change and a second frequency average spectrum corresponding to a second time period including the local minimum value in the temporal change;
a step of calculating a first signal intensity ratio as a ratio of a signal intensity in a frequency band higher than a reference frequency in the first frequency average spectrum to a ratio of a signal intensity in an entire frequency band of the first frequency average spectrum;
a step of calculating a second signal intensity ratio as a ratio of a signal intensity in a frequency band higher than the reference frequency in the second frequency average spectrum to a ratio of a signal intensity in an entire frequency band of the second frequency average spectrum;
a step of calculating a first index as a ratio of the first signal intensity ratio to the second signal intensity ratio; and
a step of determining whether the rubbing is present or absent based on the first index.

### Advantageous Effects of Invention

According to at least one embodiment of the present disclosure, it is possible to provide a rubbing determination device for a rotary machine and a rubbing determination method that can accurately determine whether rubbing is present or absent based on an AE signal.

### BRIEF DESCRIPTION OF DRAWINGS

FIG. 1 is a cross-sectional view showing a structure of a rotary machine according to an embodiment.

FIG. 2 is a block diagram showing a configuration of a rubbing determination device shown in FIG. 1.

FIG. 3 is a flowchart showing a procedure for calculating a first index.

FIG. 4 is a diagram showing an example of a temporal change in an AE signal.

FIG. 5 is a diagram showing a first frequency average spectrum and a second frequency average spectrum corresponding to the temporal change in the AE signal shown in FIG. 4.

FIG. 6 shows an example of temporal changes in an amplitude, phase, first index (30-second average), and first index (2-minute average) of the AE signal.

FIG. 7 is a flowchart showing a method for calculating a second index via a second index calculation unit shown in FIG. 2.

FIG. 8 is a graph showing the amplitude of the AE signal for each rotation order.

FIG. 9 is a flowchart showing a determination flow in a rubbing determination unit shown in FIG. 2.

FIG. 10 is a flowchart showing a modification example of FIG. 9.

### DESCRIPTION OF EMBODIMENTS

Hereinafter, some embodiments of the present disclosure will be described with reference to the accompanying drawings. However, dimensions, materials, shapes, relative dispositions, and the like of configurations described as embodiments or shown in the drawings are not intended to limit the scope of the present disclosure and are only explanatory examples.

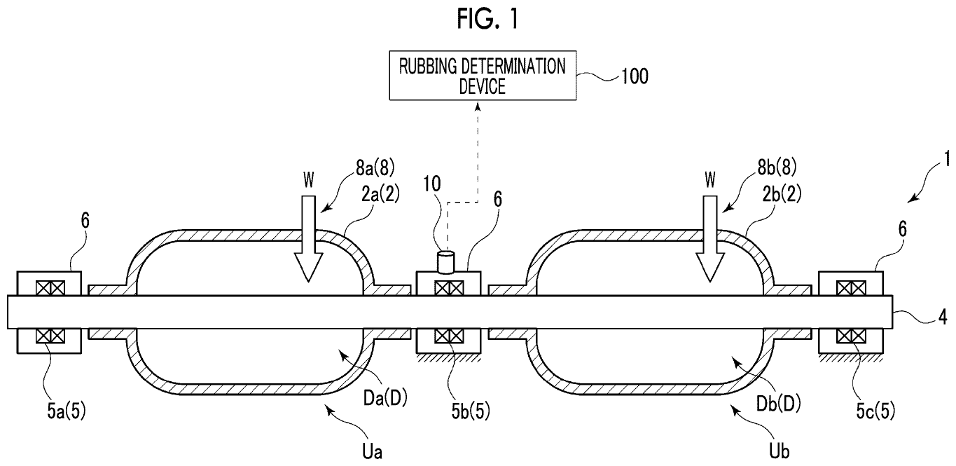

First, a rotary machine to be determined by a rubbing determination device according to at least one embodiment of the present disclosure will be described. FIG. 1 is a cross-sectional view showing a structure of a rotary machine 1 according to an embodiment.

The rotary machine 1 includes a stationary part 2 and a rotary part 4 that is rotatable with respect to the stationary part 2. The stationary part 2 is a casing of the rotary machine 1 and is stationary with respect to an outside. The rotary part 4 is rotatably supported through a bearing 5 accommodated in a bearing box 6 and can be driven by any power. The bearing box 6 is stationary with respect to the outside like the stationary part 2.

A gap D is provided between the stationary part 2 and the rotary part 4 (more accurately, the gap D is mainly formed between an innermost peripheral portion of a stator vane of the stationary part 2 and an outermost peripheral portion (tip) of a rotor blade of the rotary part 4 and may extend between the stationary part 2 to which the stator vane is attached and the rotary part 4 to which the rotor blade is attached). A working fluid W is introduced into the gap D from the outside such that the rotary part 4 is driven. The working fluid W that has been used to drive the rotary part 4 is discharged to the outside through a discharge path (not shown). During an operation of the rotary machine 1, at least one of the stationary part 2 or the rotary part 4 is deformed due to the influence of heat or the like. As a result, the gap D may be reduced, and rubbing may occur. The rubbing can be detected based on an AE signal detected by an AE sensor 10 which will be described below.

The rotary machine 1 includes a plurality of units U that are arranged along an axial direction (extension direction) of the rotary part 4. In the present embodiment, the rotary machine 1 has a first unit Ua and a second unit Ub as the plurality of units U. The rotary machine 1 may have any number of units.

The first unit Ua and the second unit Ub share the rotary part 4 and have the independent stationary parts 2 (a first stationary part 2a and a second stationary part 2b), respectively. That is, the first unit Ua is composed of the first stationary part 2a and the rotary part 4, and the second unit Ub is composed of the second stationary part 2b and the rotary part 4.

The rotary part 4 is a rotor that can be rotated by any power. In the present embodiment, power is given to the rotary part 4 by the working fluid W. The rotary part 4 may be integrally configured or may be configured by connecting a plurality of members divided in the axial direction to each other at a joint. In the latter case, the plurality of members may be made of different materials.

For example, the rotary machine 1 may use steam as the working fluid W, and each unit U may be configured as a steam turbine. In this case, a flow path of the working fluid W may be independent in each unit U or may be configured such that the units U are connected in series or in parallel. For example, when the flow paths of the working fluid W in the respective units U are connected in series, the first unit Ua may be a high-pressure turbine, and the second unit Ub may be a high-pressure turbine that can be driven by steam from the high-pressure turbine.

Further, each unit U is provided with an inlet part 8 for introducing the working fluid W into the gap D from the outside and an outlet part (not shown) for discharging the working fluid W that has completed its work in the gap D to the outside. Specifically, the first unit Ua is provided with a first inlet part 8a for introducing the working fluid W into a first gap Da, and the second unit Ub is provided with a second inlet part 8b for introducing the working fluid W into a second gap Db.

In addition, the rotary machine 1 has at least one bearing 5 (radial bearing) for supporting the rotary part 4. In the present embodiment, bearings 5a, 5b, and 5c are provided as the bearings 5. The bearing 5a is provided on one end side of the rotary part 4, the bearing 5b is provided at an intermediate position of the rotary part 4 (specifically, between the first stationary part 2a constituting the first unit Ua and the second stationary part 2b constituting the second unit Ub), and the bearing 5c is provided on the other end side of the rotary part 4 (on a side opposite to the bearing 5a). The rotary part 4 is rotatably supported by the plurality of bearings 5. As described above, each of the bearings 5a, 5b, and 5c is accommodated by the bearing boxes 6 that are stationary with respect to the outside.

The AE sensor 10 is a component for detecting an acoustic emission (AE) signal and is attached to a component, which is stationary with respect to the outside, in the rotary machine 1. In the present embodiment, the AE sensor 10 is attached to the bearing box 6 that accommodates the bearing 5b. In the rotary machine 1, for example, an AE wave is generated by the occurrence of the rubbing (friction) of a seal or the like attached to the thermally deformed stationary part 2 against the rotary part 4. For example, the AE wave generated at the location where the rubbing has occurred propagates as an elastic wave through the stationary part 2 and the rotary part 4 and is detected as the AE signal by each AE sensor 10 installed in the rotary machine 1. The AE wave generally has a frequency in a sound wave region of several tens of kHz to several MHz.

In addition, the AE sensor 10 may be attached to the bearing box 6 that accommodates the bearing 5a or 5c or may be attached to the first stationary part 2a or the second stationary part 2b.

Next, a rubbing determination device 100 for determining rubbing in the rotary machine 1 having the above-described configuration will be described. The rubbing determination device 100 is configured to include, for example, a central processing unit (CPU), a random access memory (RAM), a read only memory (ROM), and a computer-readable storage medium. Then, a series of processes for implementing various functions is stored in the storage medium or the like in the form of a program as an example. The CPU reads the program into the RAM or the like and performs information processing and arithmetic processing to implement various functions. Further, for example, the following forms may be applied: a form in which the program is installed in advance in the ROM or other storage media; a form in which the program is provided in a state of being stored in a computer-readable storage medium; and a form in which the program is delivered via wired or wireless communication means. Examples of the computer-readable storage medium include a magnetic disk, a magneto-optical disk, a CD-ROM, a DVD-ROM, and a semiconductor memory.

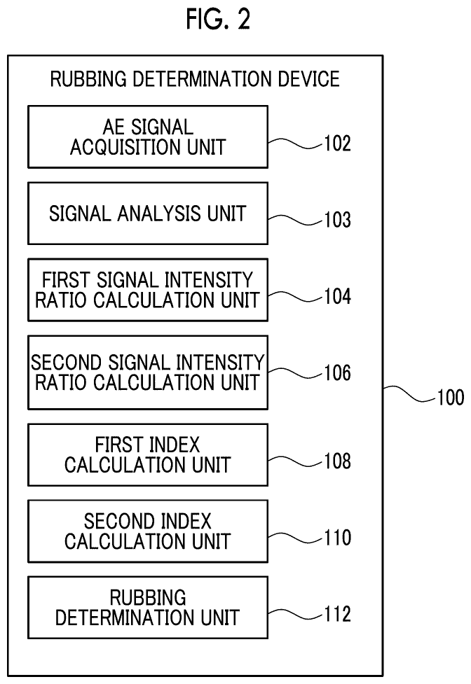

FIG. 2 is a block diagram showing a configuration of the rubbing determination device 100 shown in FIG. 1. The rubbing determination device 100 includes an AE signal acquisition unit 102, a signal analysis unit 103, a first signal intensity ratio calculation unit 104, a second signal intensity ratio calculation unit 106, a first index calculation unit 108, a second index calculation unit 110, and a rubbing determination unit 112.

The AE signal acquisition unit 102 is a component for acquiring the AE signal. As described above, the AE sensor 10 is attached to the stationary part 2 of the rotary machine 1, and the AE signal acquisition unit 102 acquires the AE signal detected by the AE sensor 10. In particular, the AE signal acquisition unit 102 is configured to continuously acquire the AE signal in terms of time to specify a temporal change in the AE signal.

The signal analysis unit 103 is a component for performing spectral analysis on the temporal change in the AE signal. The first signal intensity ratio calculation unit 104 and the second signal intensity ratio calculation unit 106 are components for calculating a first signal intensity ratio POA/OA1 and a second signal intensity ratio POA/OA2 based on the results of the spectral analysis. In addition, the first index calculation unit 108 is a component for calculating a first index I1 based on the first signal intensity ratio POA/OA1 and the second signal intensity ratio POA/OA2.

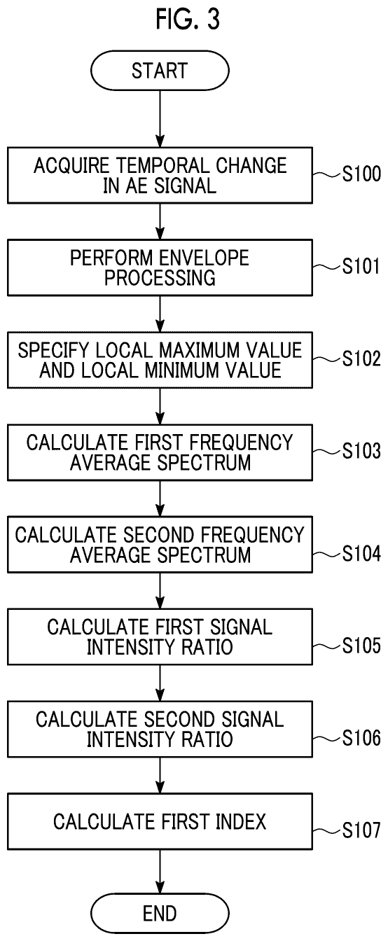

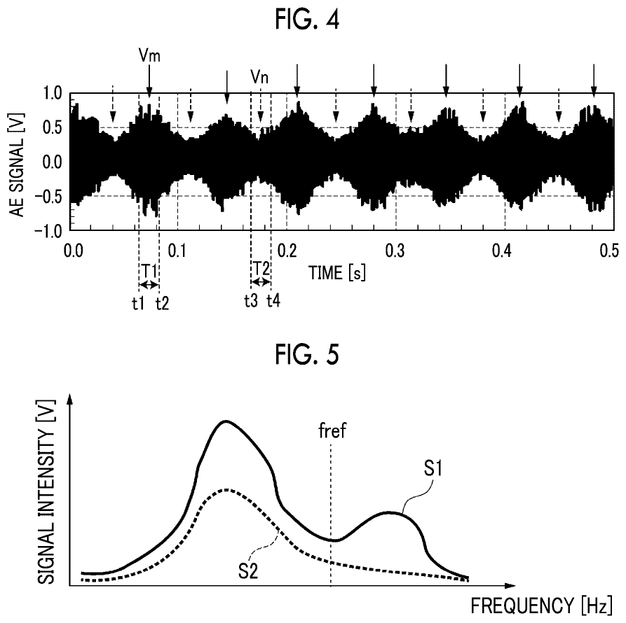

Here, a method for calculating a first signal intensity L1, a second signal intensity L2, and the first index I1 from the temporal change in the AE signal will be described in detail with reference to FIGS. 3 to 5. FIG. 3 is a flowchart showing a procedure for calculating the first index I1, FIG. 4 is a diagram showing an example of the temporal change in the AE signal, and FIG. 5 is a diagram showing a first frequency average spectrum S1 and a second frequency average spectrum S2 corresponding to the temporal change in the AE signal shown in FIG. 4.

First, the AE signal acquisition unit 102 acquires the AE signal over a predetermined period such that the temporal change in the AE signal is obtained (Step S100). Envelope processing is performed on the temporal change in the AE signal to obtain a corresponding envelope (Step S101), and a local maximum value and a local minimum value are specified (Step S102). FIG. 4 shows an example of the temporal change in the AE signal and shows a local maximum value Vm (mountain portion) and a local minimum value Vn (valley portion) specified from the envelope obtained by the envelope processing. The local maximum value Vm and the local minimum value Vn appear alternately in time series.

The signal analysis unit 103 performs, as the spectral analysis, frequency conversion (for example, Fourier transform) on a first time period T1 including the local maximum value Vm in the temporal change in the AE signal to calculate a corresponding first frequency average spectrum S1 (Step S103). The first frequency average spectrum S1 is obtained by performing an averaging process on the frequency spectra calculated for each local maximum value Vm specified in Step S102. The first time period T1 is defined as a predetermined period including the local maximum value Vm. However, for example, the first time period T1 can be set such that a start time t1 and an end time t2 of the first time period T1 and a time tm1 when the local maximum value Vm is obtained satisfy the following expression.

$$tm 1 = ( t 1 + t 2 ) / 2$$

Then, the signal analysis unit 103 performs, as the spectral analysis, frequency conversion (for example, Fourier transform) on a second time period T2 including the local minimum value Vn in the temporal change in the AE signal to calculate a corresponding second frequency average spectrum S2 (Step S104). The second frequency average spectrum S2 is obtained by performing the averaging process on the frequency spectra calculated for each local minimum value Vn specified in Step S102. The second time period T2 is defined as a predetermined period including the local minimum value Vn and can be set such that a start time t3 and an end time t4 of the second time period T2 and a time tm2 when the local minimum value Vn is obtained satisfy the following expression.

$$t m 2 = ( t 3 + t 4 ) / 2$$

Then, the first signal intensity ratio calculation unit 104 calculates the first signal intensity ratio POA/OA1 based on the first frequency average spectrum S1 calculated in Step S103 (Step S105). In Step S105, the first signal intensity ratio POA/OA1 is calculated as a ratio of a partial overall value POA corresponding to a signal intensity in a frequency band higher than a reference frequency fref in the first frequency average spectrum S1 to an overall value OA corresponding to a signal intensity in the entire frequency band of the first frequency average spectrum S1.

Then, the second signal intensity ratio calculation unit 106 calculates the second signal intensity ratio POA/OA2 based on the second frequency average spectrum S2 calculated in Step S104 (Step S106). In Step S106, the second signal intensity ratio POA/OA2 is calculated as a ratio of a partial overall value POA corresponding to a signal intensity in a frequency band higher than the reference frequency fref in the second frequency average spectrum S2 to an overall value OA corresponding to a signal intensity in the entire frequency band of the second frequency average spectrum S2.

Then, the first index calculation unit 108 calculates the first index I1 as a ratio of the first signal intensity ratio POA/OA1 to the second signal intensity ratio POA/OA2 ((POA/OA1)/(POA/OA2)) (Step S107). The reason why the first index I1 calculated in this way is an index effective for rubbing determination will be described below.

When the phase of the AE signal converges, the amplitude of the AE signal fluctuates in synchronization with a rotation speed. Specifically, the mountain portion (in the vicinity of the local maximum value Vm) with a relatively large amplitude in the temporal change in the AE signal corresponds to a signal at the time of contact, and the valley portion (in the vicinity of the local minimum value Vn) with a relatively small amplitude corresponds to a signal at the time of non-contact. As shown in FIG. 5, when the first frequency average spectrum S1 and the second frequency average spectrum S2 are calculated by applying Fourier transform to the AE signals corresponding to the mountain portion and the valley portion, the signal intensity of the first frequency average spectrum S1 corresponding to the contact (rubbing) is higher than the signal intensity of the second frequency average spectrum S2 corresponding to the non-contact in the high frequency band (for example, in the vicinity of 175 kHz). An index obtained by quantifying this feature is the first index I1.

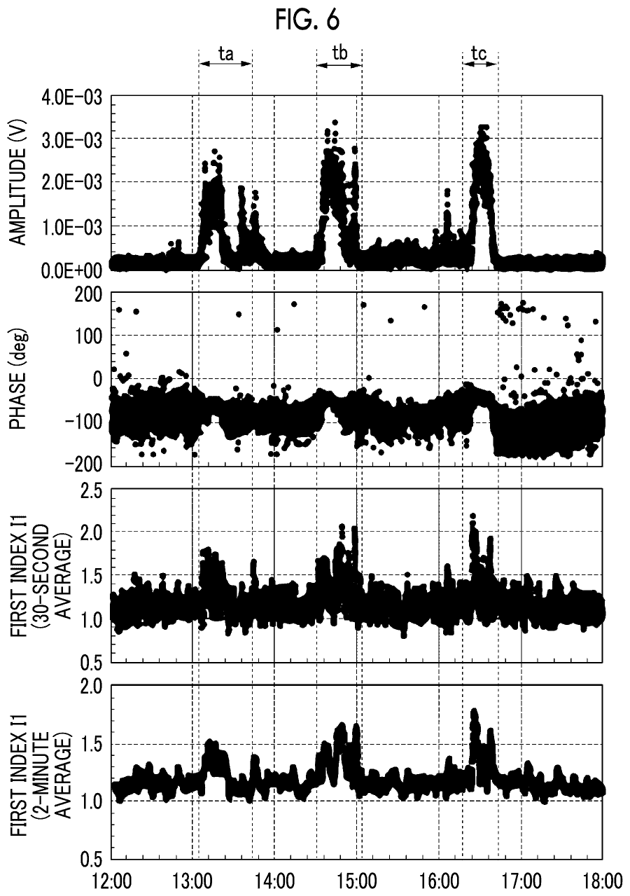

FIG. 6 shows an example of temporal changes in the amplitude, phase, first index I1 (30-second average), and first index I1 (2-minute average) of the AE signal. In this example, in periods ta, tb, and tc, the amplitude of the AE signal increases, and the convergence of the phase is confirmed, which suggests that rubbing occurs. Meanwhile, when attention is paid to the behavior of the first index I1, the first index I1 also temporarily increases in the periods ta, tb, and tc. This shows that the first index I1 is effective as an index for rubbing determination. In particular, the first index I1 is more useful as the index for rubbing determination since the behavior of the first index I1 corresponding to the 2-minute average is more pronounced than that of the first index I1 corresponding to the 30-second average in the periods ta, tb, and tc.

Further, it is shown that, in periods other than the periods ta, tb, and tc, the first index I1 is not sufficient as the index for rubbing determination since the phase always has a tendency to converge.

Furthermore, in FIG. 6, the amplitude of the AE signal increases when rubbing occurs. Therefore, there is also idea viewpoint that it is possible to perform rubbing determination without using the first index I1. However, the amplitude of the AE signal fluctuates depending on the output (load) of the rotary machine 1. Therefore, in the rubbing determination in the rotary machine 1 including a transient state, the use of the first index I1 instead of the amplitude of the AE signal makes it possible to perform rubbing determination with higher accuracy.

Returning to FIG. 2, the second index calculation unit 110 is a component for calculating the second index I2 indicating phase convergence in the temporal change in the AE signal. Specifically, the second index I2 is calculated by the following expression using a variance σ of the phase of the AE signal.

$$Second index I 2 = 1 / ( 1 + σ \hat{} 0.5 )$$

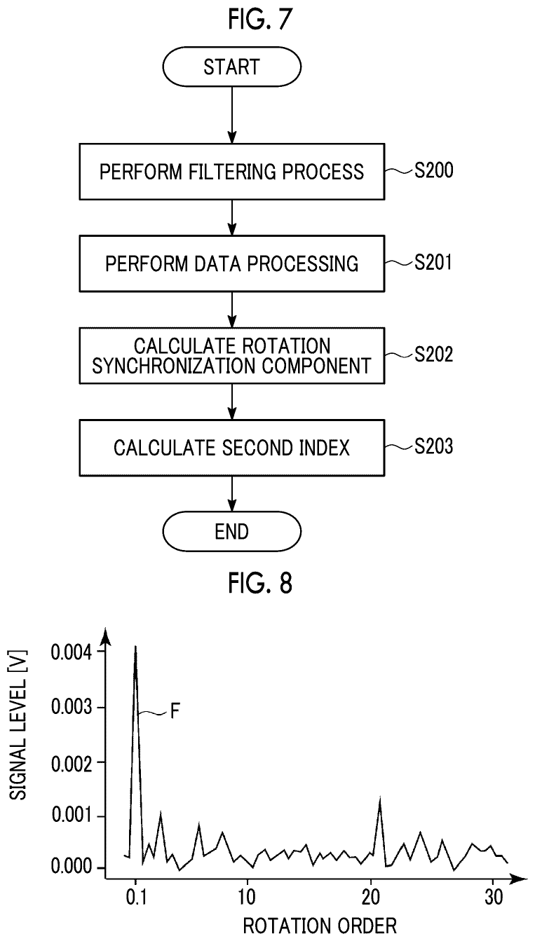

Here, a specific method of calculating the second index I2 will be described with reference to FIG. 7. FIG. 7 is a flowchart showing a method of calculating the second index I2 via the second index calculation unit 110 shown in FIG. 2.

First, the second index calculation unit 110 performs a filtering process using a predetermined filter on the AE signal acquired by the AE signal acquisition unit 102 and outputs the AE signal subjected to the filtering process to be a frequency component in a passband of the filter (Step S200). The filtering process is performed by a bandpass filter having a predetermined frequency band of the AE signal as a passband.

Then, the second index calculation unit 110 performs envelope processing, a resampling process, and an average value zeroing process on the AE signal or the AE signal subjected to the filtering process to process data (Step S201). Specifically, in the envelope processing, the envelope processing is performed on the AE signal subjected to the filtering process or the AE signal, and the AE signal subjected to the envelope processing is output. In the resampling process, resampling is performed on the AE signal subjected to the envelope processing, and the AE signal subjected to the resampling process is output. In the average value zeroing process, a process of zeroing the average value of the amplitudes in each period is performed on the AE signal subjected to the resampling, and the AE signal subjected to the average value zeroing process is output.

Then, the second index calculation unit 110 performs frequency analysis on the AE signal subjected to the average value zeroing process and outputs a rotation order analysis result F in which the frequency is represented by a rotation order as shown in FIG. 8 (Step S202). FIG. 8 is a graph showing the amplitude of the AE signal for each rotation order.

Then, the second index calculation unit 110 acquires a rotation speed 1x component C from the rotation order analysis result F and calculates the second index I2 with the above expression using the variance σ of a rotation speed 1x component extraction phase P acquired by sampling the rotation speed 1x component C (Step S203). The variance σ is calculated for the rotation speed 1x component extraction phase P calculated by performing predetermined sampling on the phase of the rotation speed 1x component C. For the rotation speed 1x component extraction phase P, the deviation of the period of the rotation speed 1x component C from the period of the rotation speed of the rotary part is acquired as the phase. The acquisition of the rotation speed 1x component C extraction phase P is performed, for example, by sampling 5 to 10 points at intervals of several seconds.

The rubbing determination unit 112 is a component for determining whether rubbing is present or absent based on at least one of the first index I1 or the second index I2. This rubbing determination may be performed based on any one of the first index I1 or the second index I2 or may be performed based on both the first index I1 and the second index I2.

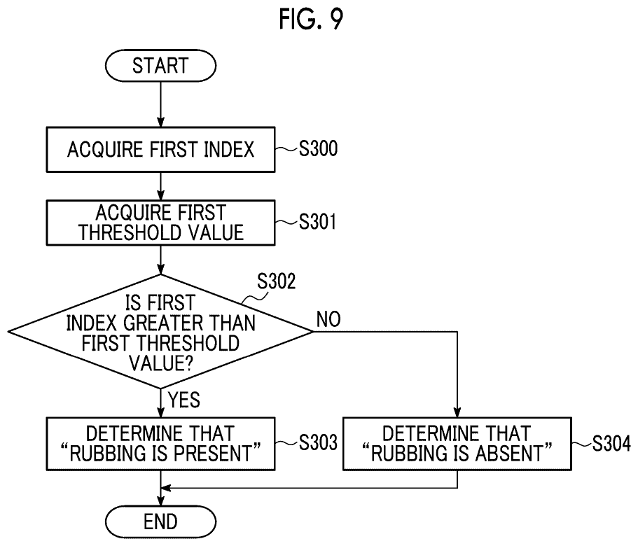

Here, a rubbing determination method performed by the rubbing determination unit 112 will be specifically described. FIG. 9 is a flowchart showing a determination flow in the rubbing determination unit 112 shown in FIG. 2. In the aspect shown in FIG. 9, the rubbing determination unit 112 determines whether rubbing is present or absent based only on the first index I1.

First, the rubbing determination unit 112 acquires the first index I1 calculated by the first index calculation unit 108 (Step S300). The first index calculation unit 108 sequentially calculates the first index I1, and the rubbing determination unit 112 acquires the first index I1 from the first index calculation unit 108 each time.

Then, the rubbing determination unit 112 acquires a first threshold value corresponding to the first index I1 (Step S301). The first threshold value may be a calculated value calculated based on an operating state of the rotary machine 1 or may be a default value stored in advance in a storage device.

Then, the rubbing determination unit 112 determines whether or not the first index I1 acquired in Step S300 is greater than the first threshold value acquired in Step S301 (Step S302). When the first index I1 is greater than the first threshold value (Step S302: YES), the rubbing determination unit 112 determines that rubbing is present (Step S303). On the other hand, when the first index I1 is equal to or less than the first threshold value (Step S302: NO), the rubbing determination unit 112 determines that rubbing is absent (Step S304). Since this rubbing determination using the first index I1 is effective regardless of the phase convergence as described above, it is possible to perform the rubbing determination with high accuracy.

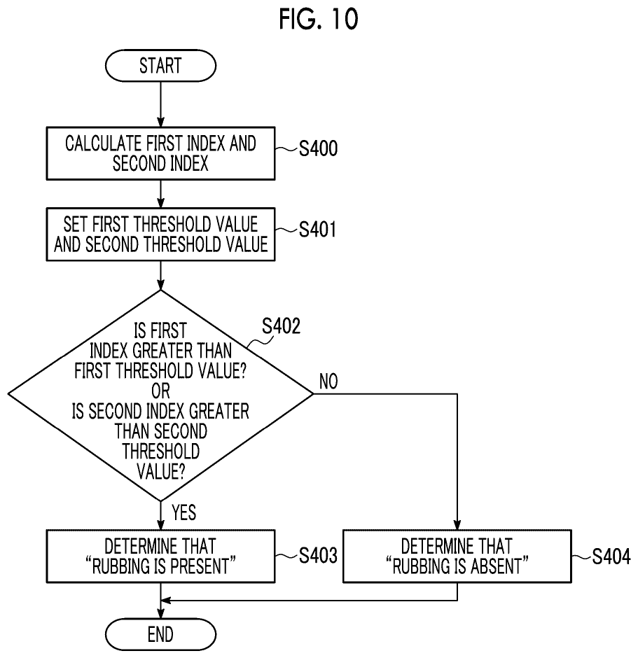

FIG. 10 is a flowchart showing a modification example of FIG. 9. In this modification example, the rubbing determination unit 112 determines whether rubbing is present or absent based on both the first index I1 and the second index I2.

First, the rubbing determination unit 112 acquires the first index I1 calculated by the first index calculation unit 108 and the second index I2 calculated by the second index calculation unit 110 (Step S400). The first index calculation unit 108 and the second index calculation unit 110 sequentially calculate the first index I1 and the second index I2, respectively, and the rubbing determination unit 112 acquires the first index I1 from the first index calculation unit 108 and the second index I2 from the second index calculation unit 110 each time.

Then, the rubbing determination unit 112 acquires a first threshold value and a second threshold value corresponding to the first index I1 and the second index I2, respectively (Step S401). The first threshold value and the second threshold value may be calculated values calculated based on the operating state of the rotary machine 1 or may be default values stored in advance in the storage device.

Then, the rubbing determination unit 112 determines whether or not the first index I1 or the second index I2 acquired in Step S400 is greater than the first threshold value or the second threshold value acquired in Step S401 (Step S402). When at least one of the first index I1 or the second index I2 is greater than the first threshold value or the second threshold value (Step S402: YES), the rubbing determination unit 112 determines that rubbing is present (Step S403). On the other hand, when both the first index I1 and the second index I2 are equal to or less than the first threshold value and the second threshold value (Step S402: NO), the rubbing determination unit 112 determines that rubbing is absent (Step S404). The use of both the first index I1 and the second index I2 in this way makes it possible to perform rubbing determination with higher accuracy, as compared to the example described above with reference to FIG. 9.

In addition, it is possible to replace the components in the above-described embodiments with well-known components as appropriate, without departing from the gist of the present disclosure, and the above-described embodiments may be combined as appropriate.

For example, the content described in each of the embodiments is understood as follows.

(1) According to an aspect, there is provided a rubbing determination device for a rotary machine for determining rubbing in a rotary machine having a rotary part that is supported by a bearing to be rotatable with respect to a stationary part.

The rubbing determination device for a rotary machine includes:
an AE signal acquisition unit that acquires an AE signal from an AE sensor attached to the stationary part;
a signal analysis unit that specifies a local maximum value and a local minimum value for an envelope obtained by performing envelope processing on a temporal change in the AE signal and that calculates a first frequency average spectrum corresponding to a first time period including the local maximum value in the temporal change and a second frequency average spectrum corresponding to a second time period including the local minimum value in the temporal change;
a first signal intensity ratio calculation unit that calculates a first signal intensity ratio as a ratio of a signal intensity in a frequency band higher than a reference frequency in the first frequency average spectrum to a ratio of a signal intensity in an entire frequency band of the first frequency average spectrum;
a second signal intensity ratio calculation unit that calculates a second signal intensity ratio as a ratio of a signal intensity in a frequency band higher than the reference frequency in the second frequency average spectrum to a ratio of a signal intensity in an entire frequency band of the second frequency average spectrum;
a first index calculation unit that calculates a first index as a ratio of the first signal intensity ratio to the second signal intensity ratio; and
a rubbing determination unit that determines whether the rubbing is present or absent based on the first index.

According to the aspect (1), it is determined whether the rubbing is present or absent based on the temporal change in the AE signal detected by the AE sensor attached to the stationary part of the rotary machine. The envelope processing is performed on the temporal change in the AE signal to create an envelope of the temporal change, and the local maximum value and the local minimum value for the envelope are specified. The first frequency average spectrum corresponding to the first time period including the local maximum value in the temporal change and the second frequency average spectrum corresponding to the second time period including the local minimum value in the temporal change are calculated. The first signal intensity ratio is calculated as the ratio of the signal intensity in the frequency band higher than the reference frequency in the first frequency average spectrum to the ratio of the signal intensity in the entire frequency band of the first frequency average spectrum. The second signal intensity ratio is calculated as the ratio of the signal intensity in the frequency band higher than the reference frequency in the second frequency average spectrum to the ratio of the signal intensity in the entire frequency band of the second frequency average spectrum. In the present aspect, the first index for determining whether the rubbing is present or absent is calculated using the first signal intensity ratio and the second signal intensity ratio. Information related to whether the rubbing is present or absent is reflected in the first index calculated in this way, regardless of a convergence state of the phase calculated from the temporal change. Therefore, the determination of whether the rubbing is present or absent based on the first index makes it possible to perform rubbing determination with high reliability.

(2) According to another aspect, in the aspect (1), the rubbing determination unit determines whether the rubbing is present or absent based on a result of averaging the first index over a predetermined period.

According to the aspect (2), since the first index calculated as described above is averaged over the predetermined period, a random component, such as noise, included in the first index is canceled out. The use of the first index from which the random component has been removed makes it possible to perform rubbing determination with higher accuracy.

(3) According to still another aspect, the aspect (1) or (2) further includes
a second index calculation unit that calculates a second index indicating phase convergence in the temporal change, and
the rubbing determination unit determines whether the rubbing is present or absent based on the first index and the second index.

According to the aspect (3), since the first index based on the signal intensity and the second index based on the phase convergence are used as described above, it is possible to perform rubbing determination with higher accuracy.

(4) According to yet another aspect, in any one of the aspects (1) to (3),
the stationary part is a bearing box that accommodates the bearing.

According to the aspect (4), it is possible to perform rubbing determination with high accuracy, based on the AE signal detected by the AE sensor installed in the bearing box.

(5) According to still yet another aspect, there is provided a rubbing determination method for a rotary machine for determining rubbing in a rotary machine having a rotary part that is supported by a bearing to be rotatable with respect to a stationary part.

The rubbing determination method for a rotary machine includes:
a step of acquiring an AE signal from an AE sensor attached to the stationary part;
a step of specifying a local maximum value and a local minimum value for an envelope obtained by performing envelope processing on a temporal change in the AE signal;
a step of calculating a first frequency average spectrum corresponding to a first time period including the local maximum value in the temporal change and a second frequency average spectrum corresponding to a second time period including the local minimum value in the temporal change;
a step of calculating a first signal intensity ratio as a ratio of a signal intensity in a frequency band higher than a reference frequency in the first frequency average spectrum to a ratio of a signal intensity in an entire frequency band of the first frequency average spectrum;
a step of calculating a second signal intensity ratio as a ratio of a signal intensity in a frequency band higher than the reference frequency in the second frequency average spectrum to a ratio of a signal intensity in an entire frequency band of the second frequency average spectrum;
a step of calculating a first index as a ratio of the first signal intensity ratio to the second signal intensity ratio; and
a step of determining whether the rubbing is present or absent based on the first index.

According to the aspect (5), it is determined whether the rubbing is present or absent based on the temporal change in the AE signal detected by the AE sensor attached to the stationary part of the rotary machine. The envelope processing is performed on the temporal change in the AE signal to create an envelope of the temporal change, and the local maximum value and the local minimum value for the envelope are specified. The first frequency average spectrum corresponding to the first time period including the local maximum value in the temporal change and the second frequency average spectrum corresponding to the second time period including the local minimum value in the temporal change are calculated. The first signal intensity ratio is calculated as the ratio of the signal intensity in the frequency band higher than the reference frequency in the first frequency average spectrum to the ratio of the signal intensity in the entire frequency band of the first frequency average spectrum. The second signal intensity ratio is calculated as the ratio of the signal intensity in the frequency band higher than the reference frequency in the second frequency average spectrum to the ratio of the signal intensity in the entire frequency band of the second frequency average spectrum. In the present aspect, the first index for determining whether the rubbing is present or absent is calculated using the first signal intensity ratio and the second signal intensity ratio. Information related to whether the rubbing is present or absent is reflected in the first index calculated in this way, regardless of a convergence state of the phase calculated from the temporal change. Therefore, the determination of whether the rubbing is present or absent based on the first index makes it possible to perform rubbing determination with high reliability.

### REFERENCE SIGNS LIST

1 Rotary machine
2 Stationary part
2a First stationary part
2b Second stationary part
4 Rotary part
5 Bearing
6 Bearing box
8 Inlet part
8a First inlet part
8b Second inlet part
10 AE sensor
100 Rubbing determination device
102 AE signal acquisition unit
104 First signal intensity ratio calculation unit
106 Second signal intensity ratio calculation unit
108 First index calculation unit
110 Second index calculation unit
112 Rubbing determination unit
Ua First unit
Ub Second unit
D Gap

1. A rubbing determination device for a rotary machine for determining rubbing in a rotary machine having a rotary part that is supported by a bearing to be rotatable with respect to a stationary part, the device comprising:
an AE signal acquisition unit that acquires an AE signal from an AE sensor attached to the stationary part;
a signal analysis unit that specifies a local maximum value and a local minimum value for an envelope obtained by performing envelope processing on a temporal change in the AE signal and that calculates a first frequency average spectrum corresponding to a first time period including the local maximum value in the temporal change and a second frequency average spectrum corresponding to a second time period including the local minimum value in the temporal change;
a first signal intensity ratio calculation unit that calculates a first signal intensity ratio as a ratio of a signal intensity in a frequency band higher than a reference frequency in the first frequency average spectrum to a ratio of a signal intensity in an entire frequency band of the first frequency average spectrum;
a second signal intensity ratio calculation unit that calculates a second signal intensity ratio as a ratio of a signal intensity in a frequency band higher than the reference frequency in the second frequency average spectrum to a ratio of a signal intensity in an entire frequency band of the second frequency average spectrum;
a first index calculation unit that calculates a first index as a ratio of the first signal intensity ratio to the second signal intensity ratio; and
a rubbing determination unit that determines whether the rubbing is present or absent based on the first index.

2. The rubbing determination device for a rotary machine according to claim 1,
wherein the rubbing determination unit determines whether the rubbing is present or absent based on a result of averaging the first index over a predetermined period.

3. The rubbing determination device for a rotary machine according to claim 1, further comprising:
a second index calculation unit that calculates a second index indicating phase convergence in the temporal change,
wherein the rubbing determination unit determines whether the rubbing is present or absent based on the first index and the second index.

4. The rubbing determination device for a rotary machine according to claim 1,
wherein the stationary part is a bearing box that accommodates the bearing.

5. A rubbing determination method for a rotary machine for determining rubbing in a rotary machine having a rotary part that is supported by a bearing to be rotatable with respect to a stationary part, the method comprising:
a step of acquiring an AE signal from an AE sensor attached to the stationary part;
a step of specifying a local maximum value and a local minimum value for an envelope obtained by performing envelope processing on a temporal change in the AE signal;
a step of calculating a first frequency average spectrum corresponding to a first time period including the local maximum value in the temporal change and a second frequency average spectrum corresponding to a second time period including the local minimum value in the temporal change;
a step of calculating a first signal intensity ratio as a ratio of a signal intensity in a frequency band higher than a reference frequency in the first frequency average spectrum to a ratio of a signal intensity in an entire frequency band of the first frequency average spectrum;
a step of calculating a second signal intensity ratio as a ratio of a signal intensity in a frequency band higher than the reference frequency in the second frequency average spectrum to a ratio of a signal intensity in an entire frequency band of the second frequency average spectrum;
a step of calculating a first index as a ratio of the first signal intensity ratio to the second signal intensity ratio; and
a step of determining whether the rubbing is present or absent based on the first index.
